(19) United States
(12) Patent Application Publication
(10) Pub. No.: US 2008/0250866 A1
(43) Pub. Date: Oct. 16, 2008

(54) Method For Monitoring Function of a Magneto-Inductive Flow Transducer

(75) Inventors: Peter Tschabold, Breitenbach (CH); Thomas Budmiger, Ettingen (CH)

Correspondence Address: BACON & THOMAS, PLLC, 625 SLATERS LANE, FOURTH FLOOR, ALEXANDRIA, VA, 22314-1176, US

(73) Assignee: Endress + Hauser Flowtec AG, Reinach (CH)

(21) Appl. No.: 11/791,712

(22) PCT Filed: Nov. 25, 2005
(86) PCT No.: PCT/EP05/56223

§ 371 Date: Jan. 15, 2008

(30) Foreign Application Priority Data
Nov. 29, 2004 (DE) 10 2004 057 680.7

(51) Int. Cl. G01F 1/58

(52) U.S. Cl. 73/861.11

(57) ABSTRACT

A method for monitoring a function of a magnetically inductive flow measuring sensor having a measuring tube and a magnetic field generator provided with at least two coils. The coils are used in the measuring mode for generating a magnetic field which penetrates the measuring tube. The method makes it possible to specifically monitor generation of the magnetic field, the coils being additionally used for function monitoring purposes. During function monitoring, at least one of the coils is used as a producer which produces a magnetic field that changes over time and penetrates at least one other coil, at least one of the other coils is used as a receiver via which a received signal induced by the magnetic field that changes over time can be derived, and functioning of the flow measuring sensor is monitored based on the received signal.

The invention relates to a method for monitoring function of a magneto-inductive flow transducer.

Magneto-inductive flow transducers are used in industrial measurements technology for measuring volume flow.

In such case, a medium, which is at least slightly electrically conductive and whose volume flow is to be measured, is caused to flow through a measuring tube, through which a magnetic field is passing essentially perpendicularly to the tube axis. The magnetic field is, in such case, as a rule, produced by two, mutually oppositely lying coils, between which the measuring tube extends. Charge carriers moved perpendicularly to the magnetic field induce, perpendicular to its flow direction, a voltage, which can be read via electrodes. To this end, e.g. two electrodes are arranged lying opposite to one another on both sides of the measuring tube in such a manner that an imaginary connecting line between the two electrodes extends perpendicularly to an imaginary connecting line between the coils. The electrodes are coupled either capacitively or galvanically with the medium. The induced voltage is proportional to a flow velocity of the medium, and thus proportional to the volume flow rate, averaged over the cross section of the measuring tube.

In magneto-inductive flow measurements, disturbances can arise. These can be attributed, for example, to a non-ideal magnetic field production, to shorting in the coils, e.g. by corrosion or vibrations, or to stray fields.

In order to be able to recognize such disturbances, function monitoring is preferably performed.

In U.S. Pat. No. 6,763,729, to this end, for example a current rise is monitored in a coil following polarity reversal in the coil, and this is compared with a characteristic curve.

In EP-A 1275940, a method is described, in which, by separate driving of two coils, intentional inhomogeneous magnetic fields are produced at times. Monitoring is done on the basis of induced voltages resulting therefrom and read on the electrodes. This form of monitoring is, however, only usable, when a conductive medium is present in the measuring tube.

It is an object of the invention to provide a method for monitoring function of a magneto-inductive flow measuring transducer permitting a targeted monitoring of the magnetic field production.

To this end, the invention resides in a method for monitoring function of a magneto-inductive flow transducer having
a measuring tube,
a magnetic field generator, which has at least two coils,
   which serve during measurement operation for producing a magnetic field passing through the measuring tube, and
   which additionally serve for function monitoring, wherein
in the function monitoring,
   at least one of the coils serves as producer,
      which produces a time-varying magnetic field, which passes through at least one other coil,
   at least one of these other coils serves as receiver, via which a received signal induced by the time-varying magnetic field is derivable, and
function of the flow measuring transducer is monitored on the basis of the received signal.

In an embodiment, at least one fixedly predetermined coil serves as producer and at least one other fixedly predetermined coil serves as receiver.

In another embodiment, at least one coil serves both as producer and also, at another point in time, as receiver.

In a further development of the method, a time-varying current flows through the producer during the function monitoring, an induced, received signal is derived in the receiver, and the current as a function time is compared with the received signal as a function of time.

In another further development of the method, a known-in-advance, time-varying current flows through the producer during the function monitoring. The received signal induced in the receiver is read, and the received signal as a function of time is compared with a reference signal as a function of time.

In another further development, a state report is derived on the basis of the function monitoring and made available to a user on-site and/or to a superordinated unit.

In a preferred embodiment, the received signal is an induced voltage dropping across the receiver.

The invention further resides in a magneto-inductive flow measuring transducer having
a measuring tube,
a magnetic field generator, which includes at least two coils,
   which serve during measurement operation for producing a magnetic field passing through the measuring tube,
   a circuit connected to the coils for function monitoring,
      including a producer circuit, which effects, during the function monitoring, that a time-varying current flows through at least one coil for producing a varying magnetic field, which passes through at least one other coil, and
      which includes a receiver circuit, which receives the received signal induced in the other coil, and
a monitoring unit, which serves for monitoring function of the flow measuring transducer on the basis of the received signal.

In a further development, the magneto-inductive flow measuring transducer has at least one coil, with which a circuit is associated, which serves during measurement operation for producing the magnetic field and during function monitoring as producer circuit.

In a further development of the last-described further development, the coils are connected in series during measurement operation and are fed by a single circuit. During function monitoring, the producer is fed by this circuit, and the receivers are electrically separated from the circuit.

An advantage of the invention is that function monitoring can also be performed, when no medium is present in the measuring tube.

A further advantage of the invention is that the function monitoring is highly independent of temperature and the medium present in the measuring tube, when the current flowing through the producer and the voltage induced thereby in the receiver are used in the function monitoring.

The invention and further advantages will now be explained in greater detail on the basis of the figures of the drawing showing two examples of embodiments; equal parts are provided with equal reference characters in the figures. The figures show as follows:

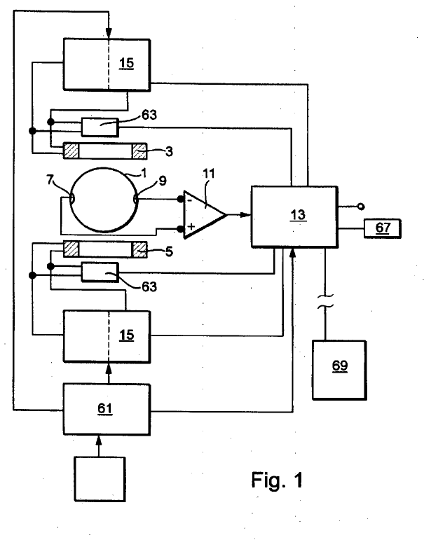

FIG. 1 schematically and partly in the form of a block diagram, construction of a magneto-inductive flow measuring transducer of the invention;

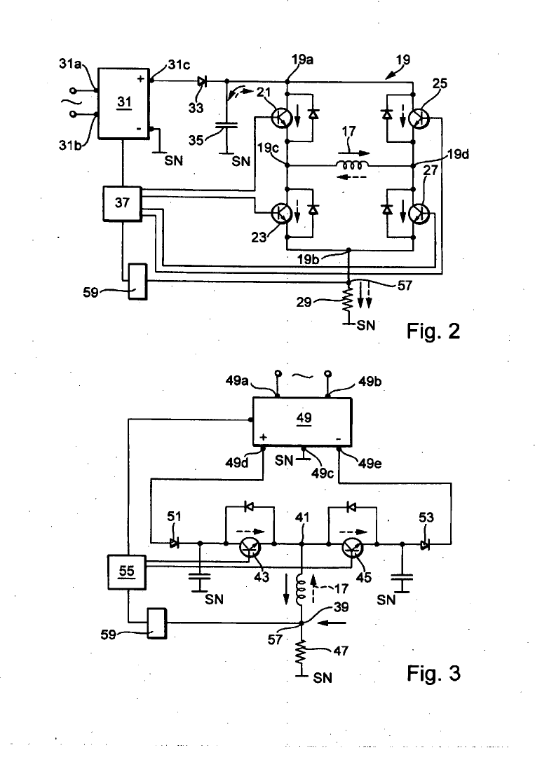

FIG. 2 an H-circuit;

FIG. 3a T-circuit;

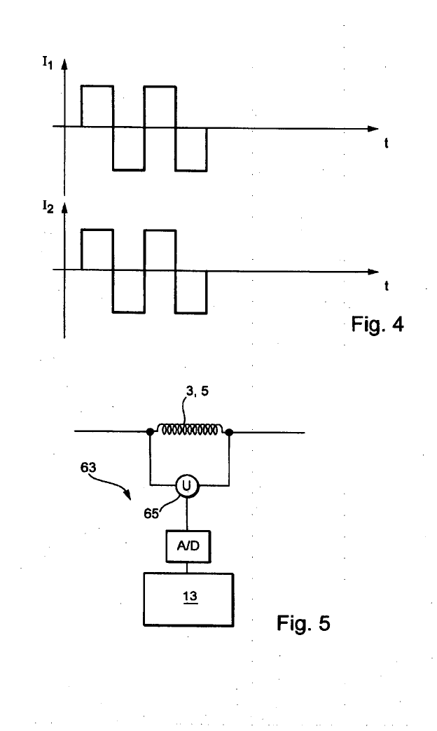

FIG. 4 waveforms of the currents flowing in the coils;

FIG. 5a receiver circuit;

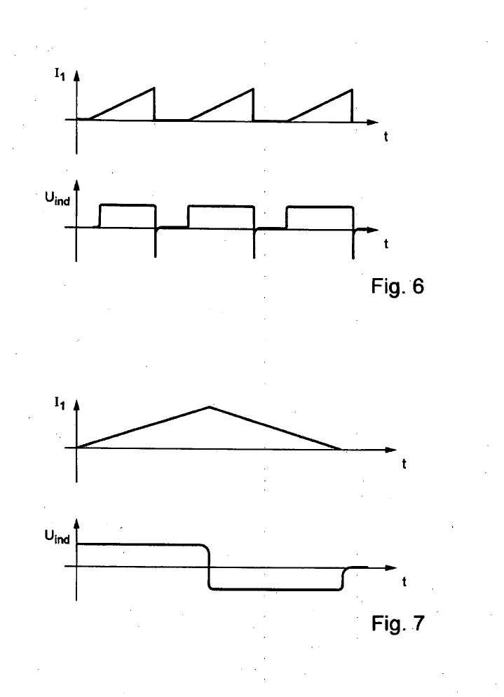

FIG. 6a sawtooth current flowing through the exciter and waveform of the associated voltage induced in the receiver;

FIG. 7a current flowing through the exciter, showing a linear rise and a subsequent linear fall, and waveform of the associated voltage induced in the receiver;

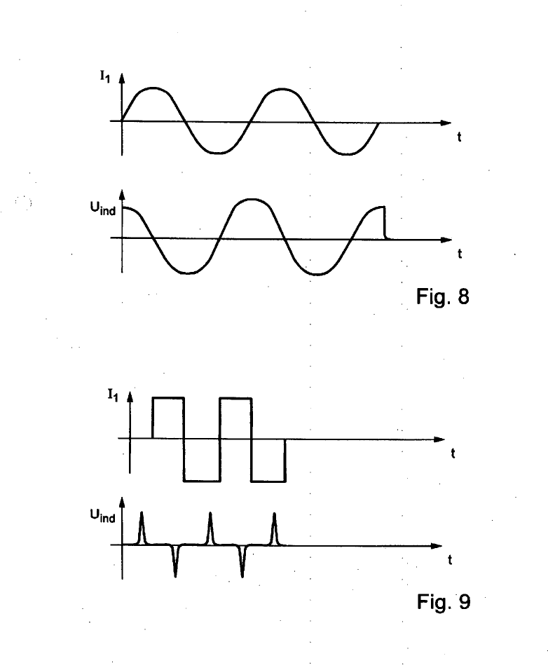

FIG. 8a current of sinusoidal waveform flowing through the exciter and waveform of the associated voltage induced in the receiver;

FIG. 9a current flowing through the exciter with the waveform shown in FIG. 4, and waveform of the associated voltage induced in the receiver; and

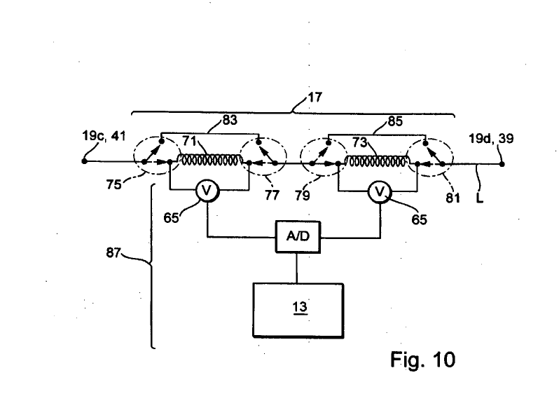

FIG. 10a circuit arrangement having two coils.

FIG. 1 shows, schematically and partially in the form of a block diagram, the construction of a magneto-inductive flow measuring transducer of the invention, which serves for measuring volume flow of an at least slightly electrically conductive, flowing medium. Included is a measuring tube 1, through which the medium flows during operation.

Further, a magnetic field generator is provided, which serves during measurement operation for producing a magnetic field passing through the measuring tube 1. To this end, the magnetic field generator includes at least two coils 3, 5. Suitable as coils are e.g. field coils lacking cores or coils with soft-magnetic cores. In the example of an embodiment shown in FIG. 1, two coils 3, 5 are provided, which are situated lying opposite to one another on both sides of the measuring tube 1. It is also possible, however, to use coil arrangements for magnetic field production wherein more than two coils are arranged around the measuring tube 1.

Charge carriers moved perpendicular to the magnetic field induce a voltage perpendicular to their direction of flow. In the illustrated example of an embodiment, two electrodes 7, 9 are provided, which are arranged lying opposite to one another on both sides of the measuring tube 1 in such a manner that an imaginary connecting line between the two electrodes 7, 9 extends perpendicular to an imaginary connecting line between the two coils 3, 5. The electrodes 7, 9 are coupled either capacitively or galvanically with the medium. The induced voltage is proportional to a flow velocity of the medium averaged over a cross section of the measuring tube 1 and thus is proportional to the volume flow rate. In order that the induced voltage not be short circuited, the regions of the measuring tube 1 coming in contact with the medium are made either of nonconductive materials or they are provided with an insulating layer.

Electrode 7 is connected with a non-inverting input and electrode 9 with an inverting input of a difference amplifier 11. The difference of the voltages sensed on the electrodes 7, 9 is proportional to the voltage induced by the magnetic field. An output of the difference amplifier 11 is connected with an evaluating unit 13, which in measurement operation ascertains the flow on the basis of the signal fed it representing the induced voltage. The result of such evaluation is made accessible for further display, evaluation and/or processing.

In order that the magnetic field produced by the coils 3, 5 passes during measurement operation through the measuring tube as homogeneously as possible, coils 3, 5 are operated during measurement operation e.g. identically to one another, electrically with equal sense—thus with the same value of current flowing through both coils 3, 5. The current is effected by a circuit 15 and controlled preferably to a constant electrical current value, e.g. 85 mA. Preferably, its direction is periodically reversed, this serving especially for largely compensating electrochemical disturbance voltages arising on the electrodes 7, 9.

In the example of an embodiment illustrated in FIG. 1, each coil 3, 5 has its own circuit 15. As an alternative to this, however, the two coils can also be connected in series and fed by a single circuit 15. This offers the advantage that only one circuit is needed and the same current automatically flows through both coils 3, 5. Synchronization is rendered unnecessary thereby.

The current flowing through a coil 3, 5 and, thus, the associated magnetic field, can be effected by allowing the circuits, or circuit, 15 to set the current flowing through the coils 3, 5. Just as well, however, by appropriate circuitry, a voltage can be set, which operates the coils 3, 5. Both cases are equivalent. Examples of such circuits 15 are the so-called H-circuits and the so-called T-circuits such as described e.g. in EP-A1 0969 268.

FIG. 2 shows a block circuit diagram of a first form of embodiment of such a circuit 15. It includes a bridge circuit 19, which is embodied as an H-circuit. In a first branch of the bridge is located a controlled current path of a first transistor 21, in a second branch a controlled current path of a second transistor 23, in a third branch a controlled current path of a third transistor 25 and in a fourth branch a controlled current path of a fourth transistor 27. Four corner points 19a, 19b, 19c, 19d of the H-circuit result from this construction. The transistors 21, 23 are connected together by the corner point 19c, the transistors 23, 27 by the corner point 19b, the transistors 25, 27 by the corner point 19d and the transistors 21, 25 by the corner point 19a. A first bridge diagonal lies between the corner points 19a, 19b and a second bridge diagonal between the corner points 19c, 19d. Lying in the second bridge diagonal is a coil arrangement 17, i.e. a first terminal of the coil arrangement 17 is connected with the corner point 19c and a second terminal of the coil arrangement 17 is connected with the corner point 19d.

During measurement operation, e.g. either the first and the fourth transistors 21, 27 or the second and the third transistors 23, 25 are controlled to conduct at the same time. In this way, in the first case (first and fourth transistors 21, 27 conducting), a current flows from the corner point 19a to the corner point 19b in the direction given by the non-dashed arrow through the coil arrangement 17. If, in contrast, the second and third transistors 23, 25 are controlled to conduct, then the same current flows in reverse direction through the coil arrangement 17, such being indicated by the dashed arrow.

Corner point 19b is connected through a resistor 29 to circuit ground SN. Resistor 29 is in series with the H-circuit and the coil current flows through resistor 29.

The H-circuit is fed via a controlled voltage source 31, which has a voltage output 31c and determines a voltage, here assumed positive, lying across the series connection, thus between the corner point 19a and the circuit ground SN. The controlled voltage source 31 is supplied from the power grid via two terminals 31a, 31b. It is also connected to circuit ground SN via an output 31d. The voltage on output 31c is applied across the anode-cathode path of a diode 33 and the corner point 19a. Interposed in the line to circuit ground SN from the cathode of the diode 33 and from the corner point 19 is a capacitor 35 of capacitance C.

Activation of the transistors 21, 23, 25, 27 is done from a controller 37, which is connected via corresponding control outputs to the control inputs of the transistors 21, 23, 25, 27. Controller 37 can be e.g. an appropriately programmed microprocessor.

FIG. 3 is a block diagram of another form of embodiment of the circuit 15. This is a so-called T-circuit, having a coil arrangement 17, with first and second terminals 39, 41, and first and second transistors 43, 45. The two transistors 43, 45 form with the coil arrangement 17 a T, with the two transistors 43, 45 forming the transverse member and the coil arrangement 17 the leg of the T.

A resistor 47 is connected in series with the coil arrangement 17 in such a manner that the coil arrangement is connected with the circuit ground SN via the resistor 47. In such case, the coil arrangement 17 is connected with the resistor 47 at its first terminal 39.

Exactly as in the case of the example of embodiment shown in FIG. 2, also the circuit 15 here is fed via a controllable voltage source 49 connected to the power grid. Thus, controlled voltage source 49 is fed from the power grid via the two terminals 49a, 49b. Its output terminal 49c is connected to the circuit ground SN.

The controlled voltage source 49 includes a positive voltage output 49d, which is applied via the anode-cathode path of a diode 51 to a first terminal of the current path of the first switching transistor 43. A second terminal of the current path of the first switching transistor 43 is connected with the second terminal 41 of the coil arrangement.

The controlled voltage source 49 includes a negative voltage output 49e, which is applied via the cathode-anode path of a diode 53 to a first terminal of the current path of the second transistor 45. A second terminal of the current path of the second transistor 45 is connected with the second terminal 41 of the coil arrangement 17.

During measurement operation, preferably in alternation, the first transistor 43 or the second transistor 45 is made to conduct, so that the current flowing through the coil arrangement 17 alternatingly reverses its direction, as indicated in FIG. 3 by the two arrows.

Activation of the transistors 43, 45 is accomplished by a controller 55, which is connected via appropriate control outputs with the control inputs of the transistors 43, 45. Controller 55 can be e.g. an appropriately programmed microprocessor.

In both of the described examples of embodiments of the circuit 15, the coil current flows through the series-connected resistor 29, 47. The current flowing through the coil arrangement 17 is, therefore, derivable, or readable, via a voltage drop across the resistor 29, 47. To this end, in both cases, a tap 57 is provided connected to the resistor 29, 47 and leading through a measuring circuit 59 to the respective controller 37, 55.

According to the invention, a method of function monitoring is performed, in which at least one of the coils 3, 5 serves as producer producing a time-varying magnetic field. The time-varying magnetic field passes through at least one other coil 5, 3 serving as receiver. Via the receiver, the received signal induced by the time-varying magnetic field is derived, or read, and function of the flow measuring transducer is monitored on the basis of the received signal.

The magneto-inductive flow measuring transducer of the invention includes a circuit connected to the coils 3, 5 for function monitoring.

This circuit includes a producer circuit, which, in function monitoring, effects that a time-varying current flows through at least one of the coils 3, 5.

The producer circuit can be an independent circuit, which acts in place of the circuit 15 during function monitoring. Preferably, however, the same circuit 15 is used for this as is also used during measurement operation for producing the magnetic field.

In the example of an embodiment illustrated in FIG. 1, two coil arrangements 17 are provided, each of which includes a coil 3, respectively 5. Activation of the two coils 3, 5 is done separately via the associated circuits 15, which are embodied, for example, in accordance with one of the examples of embodiments illustrated in FIGS. 2 and 3. Flow of the process is synchronized via a superordinated unit 61, e.g. a microcontroller or a clocking device.

During measurement operation, a current controlled to a constant value of e.g. 85 mA flows, as above explained, preferably synchronously, through the two coils 3, 5. Direction of the current is preferably periodically reversed. FIG. 4 shows current as a function of time for the first current I₁ flowing through the coil 3 and the second current I₂ flowing through the coil 5.

Function monitoring occurs outside of measurement operation. In such case, only the coils serving as exciters are operated actively, while the coils serving as receivers are operated passively.

In the following example, coil 3 serves as producer and coil 5 as receiver. For producing the time-varying magnetic field, a time-varying current I₁ flows through the coil 3. The waveform of this current I₁ is, as a start, arbitrary, so long as it varies with time. This current I₁ can be effected by means of the above-described circuits 15. It can, however, just as well be produced in some other way. Important for the invention is only that it not be constant. Any varying current effects a time-varying magnetic field, which leads to an induction related to such magnetic field.

An option is to effect the time-varying current by applying a time-varying voltage to the coil serving as producer. In such case, however, it should be taken into consideration that current essentially directly affects the magnetic field, while the physical relationship between voltage and the magnetic field depends both on temperature and also on the medium present in the measuring tube, since temperature and medium affect the electrical behavior of the coil. Due to the inductance of the coil, a time delay can arise between the voltage applied to the producer and the resulting current, respectively the resulting magnetic field.

The current can have, for example, a sawtooth-shaped waveform, as well as a waveform with a constant rise and/or fall, or a sinusoidal behavior as a function of time. However, the waveform may just as well be as described above for the measurement operation. By the periodic reversal of the current direction, as above described, a time variation is brought about, which then effects a time-varying magnetic field.

In the case of the circuits 15 described in FIGS. 2 and 3, the waveform of the current can be controlled by appropriate activating of the transistors 21, 23, 25, 27, respectively 43, 45, by the controller 37, respectively 55. It is additionally measurable from the voltage drop across the resistor 29, respectively, 47 by means of the measuring circuit 59.

The time-varying magnetic field produced by the coil 3 passes through the coil 5. Coil 5, serving as receiver, is passively operated, i.e. during function monitoring, it is not fed from the circuit 15 connected to it. To this end, e.g. all transistors 21, 23, 25, 27, respectively 43, 45, of the circuit 15 associated with the coil 5 are made non-conducting. Due to the time-varying magnetic field, induction occurs in the coil 5 serving as receiver. A correspondingly induced, received signal is logged via a receiving circuit 63 illustrated in FIG. 5 and connected to the coil 5, and the logged signal is made available to a further processing and/or evaluation.

Suitable as received signal are here both an induced voltage, as well as an induced current. While, on the exciter side, the current determines the magnetic field, on the receiver side, it is the induced voltage, which has essentially a direct relationship to the magnetic field, while the induced current depends both on the construction of the measuring circuit as well as also on the temperature and the medium in the measuring tube 1. If these influences are taken into consideration, then also current is suitable as received signal for function monitoring. Preferably, however, the induced voltage is used as received signal.

To this end, the receiver circuit 63 shown in FIG. 5 includes a voltage measuring circuit 65. This is connected between the two terminals of the coil 5 parallel to the coil 5, and logs the induced voltage U_{ind} dropping across the coil 5. An output signal of the measuring circuit 65 is digitized by means of an analog-digital converter A/D and fed to a monitoring unit. Preferably, the evaluating unit 13 serves as the monitoring unit. Of course, also a separate unit could be provided. It makes sense, however, to use the evaluating unit 13, which is already present for measuring flow.

Function monitoring is performed in a first variant by applying to the producer, here coil 3, a time-varying voltage or a time-varying current, reading, by means of the receiver circuit 63, the time-varying, induced voltage or current resulting in the receiver, here coil 5, and then comparing the curves of these two voltages or currents with one another. Preferably, for the above-stated reasons, the behavior of the current I₁ flowing through the producer is compared with the behavior of the voltage U_{ind} induced in the receiver. The waveform of the current I₁ flowing through the producer is obtained in the examples of embodiments illustrated in FIGS. 2 and 3 from the program running in the controller 37, 55. It can, however, also be read, or derived, by means of the measuring circuit 59 via the resistor 29, respectively 47, connected in series with coil 3, through which the coil current flows.

This offers the advantage that the function monitoring is essentially independent of temperature and the medium present in the measuring tube 1. The behaviors of the two curves are directly coupled together by the magnetic field. If there is no disturbance, then the waveform of the induced voltage U_{ind} behaves in the same way as the derivative of the current I₁ with respect to time. FIGS. 6 to 9 present, as a function of time, curves for the current I₁ flowing through the producer and the induced voltage U_{ind} resulting at the receiver, for four distinctive examples.

In the case of the example shown in FIG. 6, the current I₁ flowing through the exciter exhibits a sawtooth behavior. The received signal, here the induced voltage U_{ind}, is constant during the period when the current I₁ is linearly rising, and exhibits a negative spike at the point in time when the current I₁ falls to zero.

In the case of the example presented in FIG. 7, the current I₁ flowing through the exciter exhibits a linear increase and then a linear decrease directly following thereon. During the linear increase of the current I₁, the induced voltage U_{ind} has a constant, positive value, while, during the linear decrease of the current I₁, it has a constant, negative value.

In the example shown in FIG. 8, the current I₁ flowing through the exciter has a sinusoidal behavior. Then, the curve for the induced voltage U_{ind} is cosinusoidal.

The example of FIG. 9 provides the current I₁ with the behavior already explained on the basis of FIG. 4, such as can also be used during measurement operation. The resulting induced voltage U_{ind} is equal to zero during the time periods when a constant current I₁ is flowing and shows then always a marked spike, when the electrical current direction reverses. In the case of electrical current decreasing, the spike is negative, while, for electrical current increasing, it is positive.

In the first variant of function monitoring, the waveform of the current I₁ flowing through the exciter is ascertained as above described and fed to the monitoring unit, here the evaluating unit 13, where its derivative with respect to time is ascertained. A matching of the amplitudes of this derivative to the amplitudes of the induced voltage U_{ind} to be expected can be done, for example, on the basis of a conversion table previously ascertained by reference measurements or on the basis of a conversion specification derived therefrom. The matching can likewise be performed by the evaluating unit 13. From this results the waveform and the amplitudes of the induced voltage to be expected.

A comparison of the curve for the expected, induced voltage with the actually resulting curve of the received signal is performed by the monitoring unit. If only the curve of the expected induced voltage has been ascertained, then the comparison can be done for example by calculating the least squares of the normalized, expected, induced voltage and the normalized, received signal. This yields a quantitative measurement of the deviation. If additionally a matching of the amplitudes has been done, then the deviations between the expected and actual behavior of the received signal can be directly quantitatively ascertained.

If the deviation exceeds a predetermined tolerance threshold, then the function monitoring indicates a malfunction, which, for example, is presented in the form of an error report for display, triggers an alarm, issues a disturbance report, and/or brings about a safety-directed output signal of the flow measuring transducer.

Additionally, an analysis of the received signal can be performed. For example, on the basis of the difference between the expected and the actual received signals, conclusions can be drawn regarding possibly present reasons for the malfunction. To this end, preferably typical effects of specific sources of malfunction are taken into consideration, of which a few are elucidated by way of example as follows.

A possible source of malfunction relates to very strong, stray, i.e. foreign, fields. They effect that magnetically relevant materials are driven into saturation. This leads to a massive reduction in the amplitude of the received signal. If analysis of the received signal shows no measurable change of amplitude, then, conversely, it can be assumed that stray fields are having no significant influence.

Another source of malfunction is shorting in the coils. Coil shorts lead, in the case of an affected coil, to altered amplitude ratios, which are recognizable transmitter-side on the basis of the amplitude of the current I₁ and receiver-side on the basis of the amplitude of the received signal.

Corrosion alters the magnetic characteristics of involved materials. This likewise leads to changed amplitude ratios.

Another source of malfunction is vibrations. Vibrations are always a possible source of malfunction, when mechanical instabilities are present. Mechanical instabilities are, for example, loose mechanical connections in the area of the coils, e.g. between possibly present pole shoes and coil cores. Mechanical instabilities lead to unstable amplitude ratios.

Further analyses are possible and offer the advantage that more accurate malfunction reports, or malfunction surmises, can be made available, and displayed, in order to aid the user in removing and preventing malfunctions.

Preferably derived on the basis of the function monitoring is a status report, which is made available to a user on-site via a display 67 on the flow measuring transducer and/or via a superordinated unit 69 connected to the flow measuring transducer. Such a superordinated unit 69 is, for example, a process control location, a programmable logic controller or some other central or de-central, control unit connected e.g. via a bus connection.

According to a second variant, during function monitoring, a time-varying current I₁ of predetermined waveform flows through the producer. In contrast to the situation in the first variant, the current flowing through the exciter is not sensed each time and its information sent to the monitoring unit. Instead, the current is fixedly predetermined, e.g. by a corresponding procedural control in the circuit 15 associated with the exciter. This offers the advantage that the expected, induced, received signal does not have to be ascertained anew in each cycle. Instead, a reference signal corresponding to the expected received signal can be initially ascertained, e.g. plant-side by a test run, and stored in the flow measuring transducer. During function monitoring, then the actually obtained, received signal is compared with the reference signal.

In the described example, at least one fixedly predetermined coil, here coil 3, serves as producer, and at least one other fixedly predetermined coil, here coil 5, serves as receiver. Alternatively, a coil can naturally serve both as producer and, at another point in time, as receiver. Correspondingly, in the example of an embodiment illustrated in FIG. 1, both coils 3 and 5 are equipped with the receiver circuit 63 and both circuits 15 and both receiver circuits 63 are connected with the monitoring unit, here the evaluating unit 13, so that both the current flowing through the pertinent coil 3, or 5, as the case may be, and also the derived, induced received signal are available to the evaluating unit 13.

In the illustrated example of an embodiment, only two coils 3, 5 are provided. The described function monitoring is, however, completely usable analogously also in the case of magneto-inductive flow measuring transducers having more than two coils. In such case, at least one of the coils is targeted for use as exciter and at least one other coil as receiver.

During measurement operation, as described initially, preferably the same current flows with equal sense through both coils. It is thus expedient for measurement operation to connect both coils in series and to feed them by means of a single circuit 15. In this case, the coil arrangements 17 shown in FIGS. 2 and 3 contain in measurement operation two series-connected coils 71 and 73.

The function monitoring can also be performed then, when all coils are fed from a single circuit 15. For this, however, it must be assured that, during function monitoring, at least one of the coils can be operated actively and at least one other of the coils can be operated passively. This happens, according to the invention, by corresponding circuitry, in which the coils are connected in series from the single circuit 15 during measurement operation, and, in the case of function monitoring, only the producers are fed from the single circuit 15 serving as producer circuit, while the receiver is electrically separated from this circuit 15.

FIG. 10 shows a corresponding circuit arrangement, such as can be used in connection with the circuits 15 shown in FIGS. 2 and 3. This circuitry has a coil arrangement 17 lying between the terminals 39, 41, respectively between the corner points 19c, 19d. Coil arrangement 17 contains the two coils 71, 73. On both ends of each coil 71, 73 are provided controllable switches 75, 77, 79, 81, via which the coils 71, 73 lying therebetween can be placed in a long branch L connecting the terminals 39, 41, or the corner points 19c, 19d, as the case may be. Actuation of the switches 75, 77, 79, 81 can be done via corresponding connections, for example via the controller 37, respectively 55, shown in the FIGS. 2 and 3. If the coils 71, 73 are switched into the long branch L, then they are connected electrically in series. Provided for each coil 71, 73 is a parallel branch 83, 85, which can connected instead of its respective coil 71, 73 via the controllable switches 75, 77, 79, 81, in order to bypass the respective coil 71, 73.

During measurement operation, both coils 71, 73 are switched into the long branch L. In the case of function monitoring, in contrast, always only one of the coils 71, 73 is switched into the long branch L, while the other is bypassed by its associated parallel branch 83, 85.

FIG. 10 shows the switch positions by arrows. The arrows illustrated by continuous lines show the switch positions, for which the coil 73 lies in the long branch L and is thus actively operated, and the coil 71 is bypassed and is thus passively operated. The arrows shown by dashed lines show the switch positions in which the coil 71 lies in the long branch L and is thus actively operated, and the coil 73 is bypassed and thus passively operated.

If, in the function monitoring, one of the coils, e.g. coil 71, always serves as producer, and the other, e.g. coil 73, always serves as receiver, then, of course, one set of controllable switches, in this example the two switches 75, 77, and a parallel branch, in this example the parallel branch 83, can be omitted.

For all coils 71, 73, which can be employed by corresponding circuitry as receivers, a receiver circuit 87 is provided, which is constructed e.g. analogously to the receiver circuit shown in FIG. 5. In such case, each such coil 71, 73 is connected to a measuring circuit 65 connected in parallel therewith for logging the induced voltage U_{ind} dropping across the pertinent coil 71, 73.

The output signals of the measuring circuits 65 are digitized by means of the analog-digital converter A/D and fed to the evaluating unit 13.

During measuring operation, the coils 71, 73 are switched in series by having the switches 75, 77 assume the dashed switch positions shown in FIG. 10 and the switches 79, 81 the switch positions shown by the continuous lines.

### LIST OF REFERENCE CHARACTERS

1 measuring tube
3 coil
5 coil
7 electrode
9 electrode
11 difference amplifier
13 evaluating unit
15 circuit
17 coil arrangement
19 bridge circuit
19 a b c d corner points
21 first transistor
23 second transistor
25 third transistor
27 fourth transistor
29 resistor
31 controlled voltage source
31a terminal
31b terminal
31c voltage output
31d output
33 diode
35 capacitor
37 controller
39 first terminal
41 second terminal
43 first transistor
45 second transistor
47 resistor
49 controllable voltage source
49a terminal
49b terminal
49c output
49d positive voltage output
49e negative voltage output
51 diode
53 diode
55 controller
57 tap
59 measuring circuit
61 superordinated unit
63 receiver circuit
65 voltage measuring circuit
67 display
69 superordinated unit
71 coil
73 coil
75 controllable switch
77 controllable switch
79 controllable switch
81 controllable switch
83 parallel branch
85 parallel branch
87 receiver circuit
L long branch
SN circuit ground

1-10. (canceled)

11. A method for monitoring a function of a magneto-inductive flow transducer having a measuring tube, and a magnetic field generator, which has at least two coils, the method comprising the steps of:
producing by the at least two coils during measurement operation a magnetic field passing through the measuring tube, and additionally serving for function monitoring;
at least one of the coils serves as producer, which produces a time-varying magnetic field, which passes through at least one other coil;
at least one of the other coils serves as receiver, via which a received signal induced by the time-varying magnetic field is derivable; and
monitoring the function of the flow measuring transducer on the basis of the received signal.

12. The method as claimed in claim 11, wherein:
at least one fixedly predetermined coil serves as producer and at least one other fixedly predetermined coil serves as receiver.

13. The method as claimed in claim 11, wherein:
at least one coil serves both as producer and also, at another point in time, as receiver.

14. The method as claimed in claim 11, wherein:
a time-varying current (I₁) flows through the producer during the function monitoring;
an induced, received signal is derived in the receiver; and
the time-varying current (I₁) as a function time is compared with the received signal as a function of time.

15. The method as claimed in claim 11, wherein:
a known-in-advance, time-varying current flows through the producer during the function monitoring;
the received signal induced in the receiver is read; and
the received signal as a function of time is compared with a reference signal as a function of time.

16. The method as claimed in claim 11, further comprising the step of:
deriving a state report on the basis of the function monitoring, and making the state report available to a user on-site and/or to a superordinated unit.

17. The method as claimed in claim 11, wherein:
the received signal is an induced voltage dropping across the receiver.

18. A magneto-inductive flow measuring transducer comprising:
a measuring tube;
a magnetic field generator, which includes at least two coils, which serve during measurement operation for producing a magnetic field passing through said measuring tube;
a circuit connected to said at least two coils for function monitoring, which includes a producer circuit, which effects, during the function monitoring, that a time-varying current flows through at least one of said at least two coils for producing a varying magnetic field, which passes through at least one other of said at least coils and which includes a receiver circuit, which receives the received signal induced in said other of said at least two coils; and
a monitoring unit, which serves a monitoring function of the flow measuring transducer on the basis of the received signal.

19. The magneto-inductive flow measuring transducer as claimed in claim 18, wherein:
said at least one of said at least two coils, with which a circuit is associated, serves during measurement operation for producing the magnetic field and during function monitoring as a producer circuit.

20. The magneto-inductive flow measuring transducer as claimed in claim 19, wherein;
certain coils of said at least two coils are, during measurement operation, connected in series and fed by said circuit; and
during function monitoring, producers are fed by said circuit, and receivers are electrically separated from said circuit.
